(19) United States
(12) Patent Application Publication
(10) Pub. No.: US 2020/0210986 A1
(43) Pub. Date: Jul. 2, 2020

(54) Method and Mobile Application for an on-the-go Purchase via Secured Information Between Parties

(71) Applicant: Michael Allen, Lake Charles, LA (US)

(72) Inventor: Michael Allen, Lake Charles, LA (US)

(21) Appl. No.: 16/232,561

(22) Filed: Dec. 26, 2018

(51) Int. Cl. G06Q 20/32; G06Q 20/38; G06Q 30/06; G06Q 30/02

(52) U.S. Cl. CPC G06Q 20/322; G06Q 20/382; G06Q 30/0214; G06Q 30/0282; G06Q 30/0635

(57) ABSTRACT

A disclosed system for mobile purchasing between parties via a secured network includes a sending module to send a request to purchase (RTP) signal from a purchasing party to a vending party. The RTP signal includes a purchase request regarding the purchasing party received via the RTP signal at the vending party. The system additionally queries the vending parties to accept the purchase request. Alternatively, the vending parties present a query to the purchasing party for the purchasing party to accept. The system is also configured to determine a vector and an ETA between the purchasing party and the vending parties. The system additionally returns an enable to purchase (ETP) signal from the vending party to the purchasing party. The ETP is based on a positive response to the query by the purchasing party. The ETP signal includes secured data from the vector and ETA calculations and the purchase request.

### BACKGROUND OF THE INVENTION

A telephone sales transaction involving a caller ID (identification) transmits a caller's telephone number and name to the called party's telephone during the ringing signal before the call is answered. The caller's name and number are most commonly displayed on the called party's telephone enabling the called party to screen calls from telemarketers and other unwanted calls. However, it may also allow the called party to be evasive and hard to locate.

Caller ID works on the concept of informed consent but also poses issues for personal privacy. Generally, unlisted numbers are blocked. Non-published and regular listed numbers are not usually blocked. If desired, callers need to take steps to ensure that their number will not be displayed. In some locations in the United States, regulators allow (or require) blocking to be automatic, transparent to the caller.

Where blocking is applied at the time a call is made, callers can block their numbers from being displayed by dialing a special code before making their call. However, their number may still be transmitted through the entire telephone network, with the destination phone expected to honor the blocking request.

Similarly, a feature known as anonymous caller rejection rejects all calls when the caller's number is blocked. In other instances, anonymous calls are routed to a service, where the caller is required to announce him or herself. The service then asks the called party if they want to accept or reject the call.

Sales transactions have developed electronically with smart phones and mobile networks. There is a need in the market of sales and services for a method and application thereof for smart phone users to purchase and secure services without giving away personal information like transit and location information.

### SUMMARY OF THE INVENTION

A disclosed system for mobile purchasing between parties via a secured network includes a sending module configured to send a request to purchase (RTP) signal from a purchasing party's communication device to a vending party communications devices. The RTP signal includes a purchase request regarding the purchasing party. The system also includes a receiving module configured to receive the RTP signal at the vending party communications devices. The system additionally includes presenting the purchasing party's purchase request to the vending parties and querying the vending parties to accept the purchase request. Alternatively, the vending parties present a query to the purchasing party for the purchasing party to accept.

The system also includes a securing module configured to perform a plurality of calculations for determining a vector (distance and direction) and an ETA (estimated time of arrival) between the purchasing party and the vending parties. A location for each vendor and a result of the calculations and location comprise a vending party secured data communicated to the purchasing party. The system additionally includes a returning module configured to return an enable to purchase (ETP) signal from the vending party communications devices to the purchasing party's device. The ETP is based on a positive response to the query by the purchasing party. The ETP signal includes secured data from the vector and the ETA calculations and the purchase request.

Embodiments of the disclosure also include a computer program product, also known as a mobile application, comprising a computer readable medium having computer useable program code. The program code is executable to perform operations for mobile purchasing between parties via a secured network for sending a request to purchase (RTP) signal from a purchasing party's communication device to a plurality of vending party communications devices, the RTP signal including a purchase request regarding the purchasing party. The program code also includes receiving the RTP signal at the plurality of vending party communications devices and presenting the purchasing party's purchase request to the plurality of vending parties and querying the plurality of vending parties to accept the purchase request.

The program code additionally includes securing a plurality of calculations for determining a vector and an ETA (estimated time of arrival) between the purchasing party and the plurality of vending parties and a location for each vendor of the plurality of vending parties, a result of the calculations and location comprising a secured vending party data. The program code further includes returning an enable to purchase (ETP) signal from the plurality of vending party communications devices to the purchasing party's device based on a positive response to the query by the purchasing party, the ETP signal including the secured data from the vector and the ETA and the purchase request.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a flow chart of a method and mobile application for a tires on-the-go purchase via secured information between parties in accordance with an embodiment of the present disclosure.

FIG. 2 is a flow chart of the technical steps for an on-the-go purchase via secured information between parties in accordance with an embodiment of the present disclosure.

FIG. 3 depicts electronic communications of a method and mobile application for an on-the-go purchase in accordance with an embodiment of the present disclosure.

FIG. 4 is a flow chart of an embodiment of a method and mobile application for an on-the-go purchase in accordance with the present disclosure.

FIG. 5 depicts a wireless phone display for a method and mobile application for an on-the-go purchase in accordance with an embodiment of the present disclosure.

FIG. 6 is a flow chart of a method for a bypass or override of a location determination in accordance with an embodiment of the present disclosure.

FIG. 7 is a block diagram of system components of the tires on-the-go purchasing method and mobile application in accordance with an embodiment of the present disclosure.

FIG. 8 is a flow chart of a computer program product for an on-the-go purchase in accordance with an embodiment of the present disclosure.

FIG. 9 is a flow chart of a method and mobile application for a communications protocol between parties in an on-the-go purchase in accordance with an embodiment of the present disclosure.

FIG. 10 is an illustration of a screen on a mobile phone for the disclosed mobile application in accordance with an embodiment of the present disclosure. Throughout the description, similar reference numbers used in one figure may be used to identify similar elements in other figures.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the claims.

Throughout the present disclosure, the term ‘purchasing party’ may comprise a single or multiple callers or users of a communications device and digital subscription service. A communications device may comprise a landline telephone, a cellphone or smartphone, a computer connected to a digital phone such as Voice Over Internet Protocol (VIOP) any type of electronic electromagnetic communication device through voice, text, pictures, etc. The term ‘vending party’ is similarly used throughout the disclosure. The term ‘network’ may comprise one of a voice, a data, an internet, a wireless and a satellite technology and any combination thereof such as VOIP phone.

In many instances, it is desirable and even necessary to know the location of a vending party and distance between two or more parties in a sales transaction. One particularly advantageous application of the present disclosure is for predicting the time of arrival of delivered vendor products and services. It is common tire sales patrons to wait for hours to have tires installed in a large metropolitan area. Customers waiting for tire installation on one side of the city may be required to take several hours off work to be present for installation in another side of the city. Also, routes may need to be changed because of road construction, lunch detours or a missing customer. Therefore, it is desirable to be able to locate a tire vendor and to update arrival times for subsequent service not only for the customer's sake but also for efficient use of business resources.

On the other hand, it is not always desirable for a purchaser to disclose his or her location or to enable a vending party to locate them such as when there is no business or personal relationship between the two parties. In order that personal privacy may be protected, the present disclosure employs a protocol, system and computer program product for secure data transfer needed for a sales and service transaction.

Therefore, a purchaser and a vending party are both able to handshake in a series of electronic transactions designed to transmit distance and location information between them. Both the purchaser and the vending party have an embodiment of the disclosed computer program product and mobile application loaded onto their wireless and/or landline phones and computer systems. A user may access an embodiment of the disclosed mobile application by logging onto a website and registering on the site with information such as name, address and mobile telephone number, tire size, tire brand name, installation time frame, etc. Once a user, purchaser or vending party registers his or her handset, they may choose a subscription level of options, similar to mode of payment via credit cards, bank electronic funds transfers, etc.

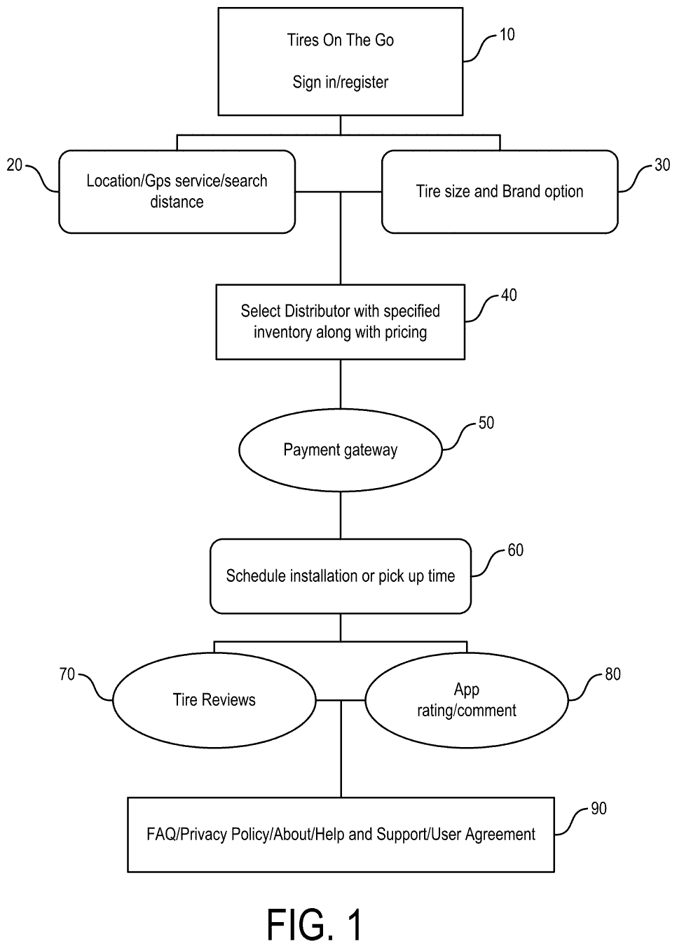

FIG. 1 is a flow chart of a method and mobile application for tires on-the-go purchase via secured information between parties in accordance with an embodiment of the present disclosure. The disclosure includes a sign-in/register module 10, a location/gps service/search and distance module 20, a tire size and brand option module 30, a select distributor with specified inventory along with pricing module 40, a payment gateway module 50, a schedule installation or pick up time module 60, a tire reviews module 70, an application for rating/comments module 80 and a FAQ/Privacy Policy/About/Help and Support/User Agreement module 90.

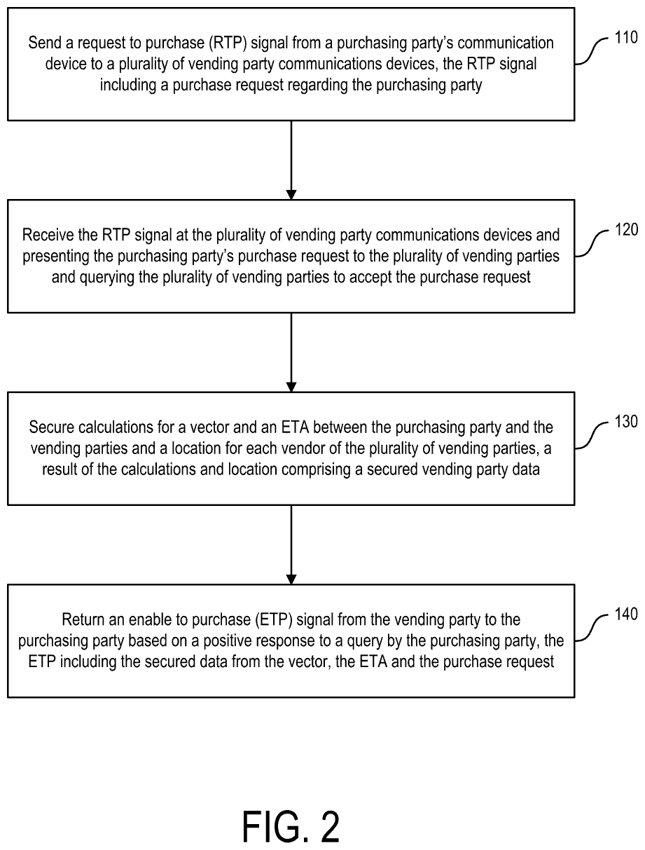

FIG. 2 is a flow chart of the technical steps of an on-the-go purchase via secured information between parties in accordance with an embodiment of the disclosure. The method and mobile application further includes sending 110 a request to locate (RTP) signal from a purchasing party's communication device to a vending party's communication device, the RTP signal including secure data regarding the purchasing party. The disclosed method also includes receiving 120 the RTL signal at the vending party's communication device and presenting the purchasing party data to the vendor party and querying the vendor party to accept the request. The method also includes securing 130 a plurality of calculations for determining a distance between the purchasing party and the vending party and a location for each party, a result of the calculations comprising the secured purchasing party data. The disclosed method may additionally include returning 140 an enable to purchase (ETP) signal from the vending party's device to the purchaser's device based on a positive response to the query, the ETP signal including the secure data regarding the vending party.

In an embodiment, the method and mobile application further includes the purchasing party choosing one of the vending parties for a sales and a service of the purchase request via the network of a voice, a data, an internet, a wireless and a satellite technology and any combination thereof. The disclosure further includes the purchasing party providing a review of a chosen vending party's sales and service to other purchasers subscribing to the method. The disclosure further includes presenting a plurality of reviews from other purchasing parties regarding a sales and a service of the vending parties. An administrator of the disclosed method and mobile application also takes a commission for a sale between the purchasing party and one of the plurality of vending parties. Also, the vendors are enabled to generate various reports related to a sales, a profit and an inventory related to the method.

A communications device comprises any electronic electromagnetic communications device including a landline telephone, a cellular telephone, a voice-over-internet-protocol phone, a texting device, a computer, a personal digital assistant, a walkie-talkie, a satellite phone, a smart wrist-watch and the like. The purchasing party's data includes at least one of a name and a purchasing party's location based on whether the purchasing party is subscribed to an ‘on-the-go’ service and the purchasing party does not block a disclosure of his or her location. The vending party data includes at a vending party's name and a location based of the plurality of vending parties and whether the vending party is subscribed to an ‘on-the-go’ service and the vending party does not block a disclosure of its location.

Securing a plurality of calculations for determining a vector and an ETA between the purchasing party and the vending parties further includes triangulating a location and a distance from the purchasing party to the plurality of vendors using a transmission time there between and multiple stationary wireless transmitters, landline relays and internet routers in the network. Also, the secure calculations for determining a vector and an ETA between the purchasing party and the vending parties and a location for each, further includes trilaterating data from GPS satellites to determine the distance there between and a respective location information for the parties.

An embodiment includes bypassing the RTP accept query and automatically returning an ETP signal from the purchasing party's communication device to the plurality of vending party communication devices for certain business and personal relationships, the bypass based on one of a variable set in software and a switch set in the communications devices.

Another embodiment includes blacklisting an ETP signal coming from an undesired vending party specified by the purchasing party and automatically responding negatively to the query to accept the request and blocking the vector, the ETA and location data from calculation and transfer via the network between the parties.

The estimated arrival time (ETA) between the parties is based on the calculated speed and direction of travel of the purchasing party relative to the vending parties.

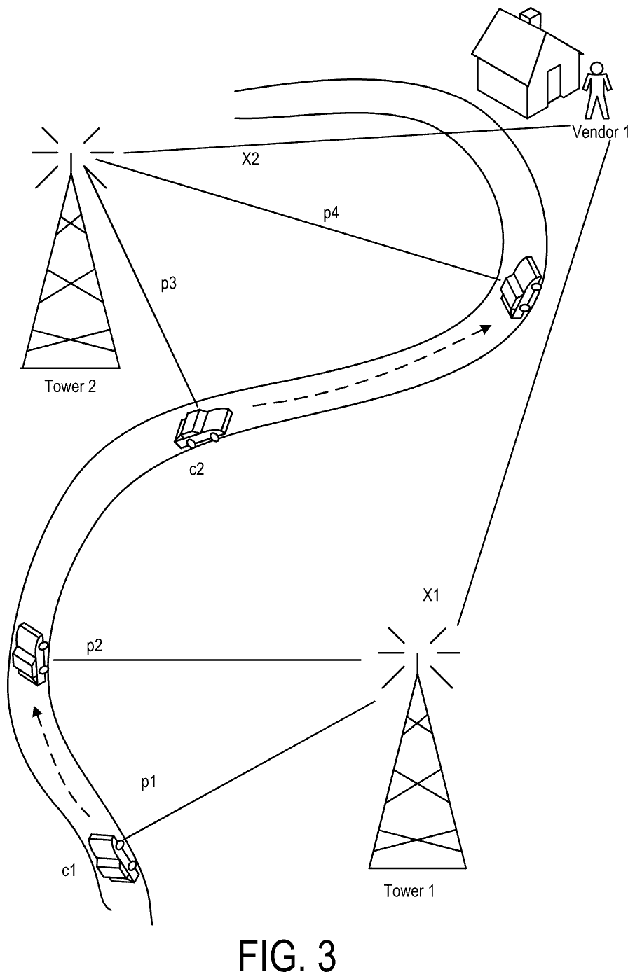

FIG. 3 depicts electronic communications of a method and mobile application for an on-the-go purchase in accordance with an embodiment of the present disclosure. Vendor 1, as a subscriber to the disclosed mobile application and service through a telecom or internet service provider, may respond to a request X1 to the driver cl which is relayed through tower 1 to the driver in transaction p1. Tower 1 transmits an RTP from the caller because tower 1 is closer to the driver than tower 2 in the depiction. The driver transmits the RTP at his or her phone and a message may appear on the driver's phone alerting the driver that a vendor, identified by name, phone number, and/or location (call origination point) wishes to sell a product and/or service to the driver. An inquiry may appear on the driver's phone display such as, “Vendor John Doe, phone number, location, and distance.” If the driver does respond affirmatively, the driver's phone may send the ETP signal back to the vendor through the transmission tower 1. If the driver does not wish to disclose his or her location, the driver's phone will not send location information in the ETP signal to the vending party and the vendor will not be enabled to compute the distance between them or the location of the driver. However, in a business relationship, an ETP override is available which will bypass the driver's input for the ETP signal transmission to the vendor and automatically allow distance and/or location of the called party to be computed.

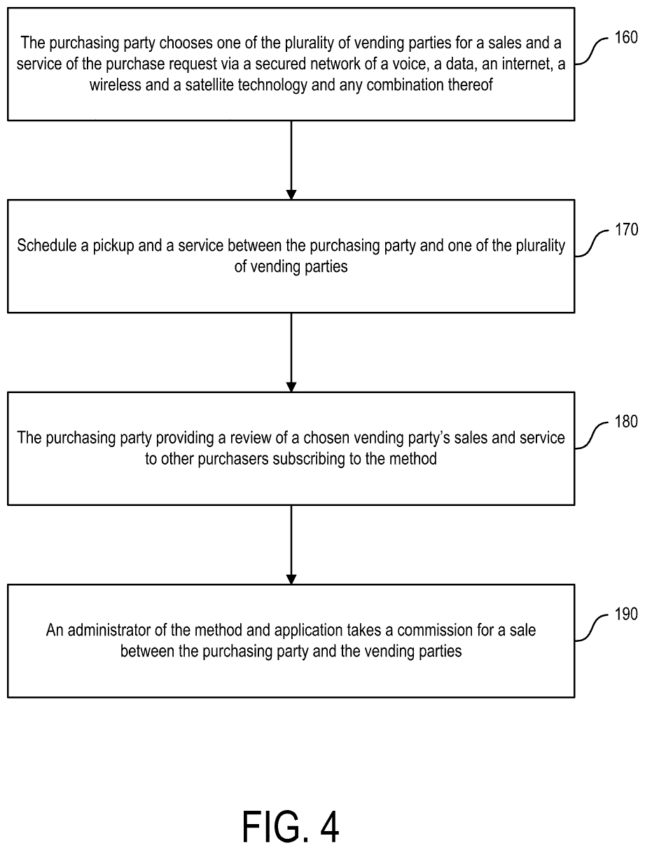

FIG. 4 is a flow chart of an embodiment of a method and a mobile application for an on-the-go purchase in accordance with the present disclosure. The flow chart includes the purchasing party choosing 160 one of the vending parties for a sales and a service of the purchase request via a secured network. The flow chart also includes scheduling 170 a pickup and a service between the purchasing party and one of the vending parties. The flow chart additionally includes the purchasing party a review of a chosen party's sales and services to other purchasers subscribing to the mobile application. The flow chart further includes an administrator of the mobile application taking a commission 190 for a sale between the parties.

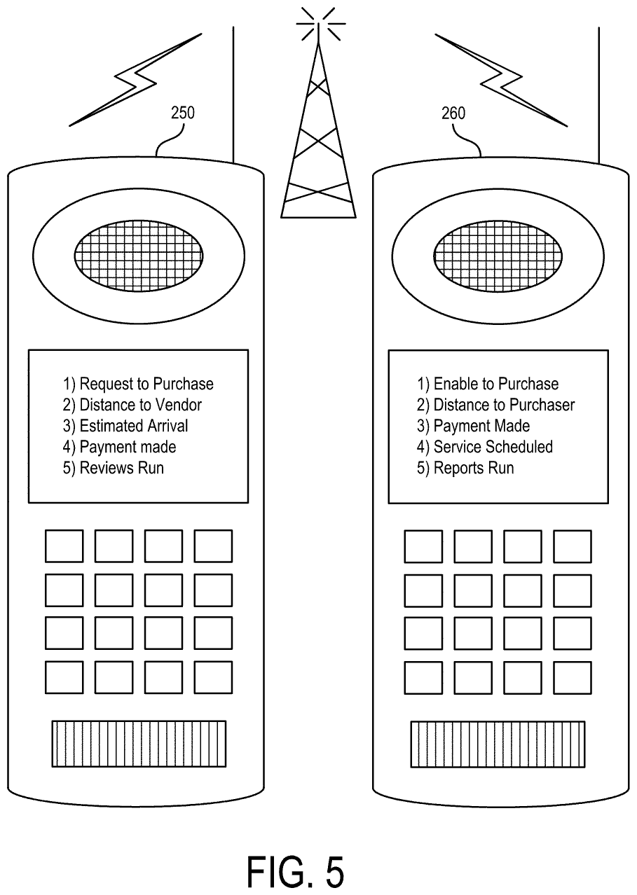

FIG. 5 depicts a wireless phone display for a method and mobile application for an on-the-go purchase in accordance with an embodiment of the present disclosure. An embodiment of the present disclosure may comprise conference calls placed from a purchaser to multiple vendor parties at once though multiple receiving phones are not depicted in FIG. 2. The purchaser's phone 250 on the left may display one or all of the depicted options for disclosing the purchaser's location, options for an RTP, distance to vending party, estimated time of arrival based on present speed of the purchasing party. Options for making a payment to the vending party and generating a review are also presented. The vending party's phone 260 on the right may display the purchaser's name and/or location, ETP options, distance to the purchaser (which is equivalent to the distance to the vending party displayed on the purchaser's phone), estimated time of arrival based on present speed of the caller. Options for scheduling a service of the purchaser and running a report or sales receipts are also presented. Location information may be expressed in either geographical coordinates or in standard postal zip codes. Distance may be expressed in English, metric or equivalent units at the option of the phone owner/operator.

Throughout this disclosure, the terms RTP and ETP are used as acronyms to describe the handshaking transactions between transacting parties. Other terms less technical or even arbitrary may also be used on the displays of the caller and called party's phones to indicate similar handshaking transactions. Menus and options for managing the disclosed method and mobile application are also included in an embodiment. For instance, after receiving the prompt, “Do you wish to disclose your location to the vending party?” the purchasing party may choose an option on his phone display such as “Yes, allow disclosure of my location and purchase information only this one time,” or “Yes, allow disclosure of my location and purchase information for all requests,” or “No, do not allow disclosure of my location and purchase request to this vendor at this time.” The phone and display design are merely representative of phones that may be used by the purchaser and the vending party. Phones and displays of various makes and models are included in embodiments of the disclosure.

Briefly returning to FIG. 2, the time for an RTP signal from Vendor 1 to reach tower 1 and tower 2 to be used to triangulate the location of Person 1 is relative to the two stationary tower transmitters. For example, the time it took p1 to be received at tower 1 may determine a radial distance from tower 1. The time it took p1 to be received at tower 2 may determine a radial distance from tower 2. Where the distance between the two towers is known, the intersection of the two radii therefore may triangulate the location of vendor 1.

Likewise, the time for the driver's signals to reach towers 1 and 2 may be used to triangulate the location and distance of the driver from towers 1 and 2. Hence, the sum of the distance from the driver to either tower and the distance from either tower to vendor 1 may equal the distance between the driver and the vendor.

Additionally, a second transmission p2 from the driver's phone may be sent in order for the driver's speed to be calculated. Therefore, the computer program product of the present system, method and mobile application may ping the location of the driver a time period t2 from when the vendor responded to a call from the driver. The time it takes for a response from the driver's phone to tower 1 and back to the vendor may then be used to triangulate the updated location of the driver and hence his or her approximate speed on a given route toward the vendor.

Similarly, the location and distance of a second driver c2 from Vendor 1 may be determined from triangulation between towers 1 and 2 and driver 2 in a second transmission X2. Embodiments of the disclosure may therefore compute and track multiple called parties including utilizing phone memory for storing the location and/or distance of a called party at multiple time points. The disclosure also includes a means for downloading location and distance data to a computer device for further processing and documentation. Disclosed embodiments may also include backend processes such as reviews by both the purchaser and the vendor parties and reports for either party and for an administrative party.

Distance between parties may be likewise calculated from GPS trilateration data. Trilateration data may predetermine the location of the purchaser and the vending party so that the disclosed system may calculate the distance between the parties. Subsequent location data may also allow the disclosed system to calculate an estimated arrival time of the driver at any point along the driver's route to the vendor. The vendor or manager in the foregoing example may therefore apprise customers of a precise service time for their tires and car.

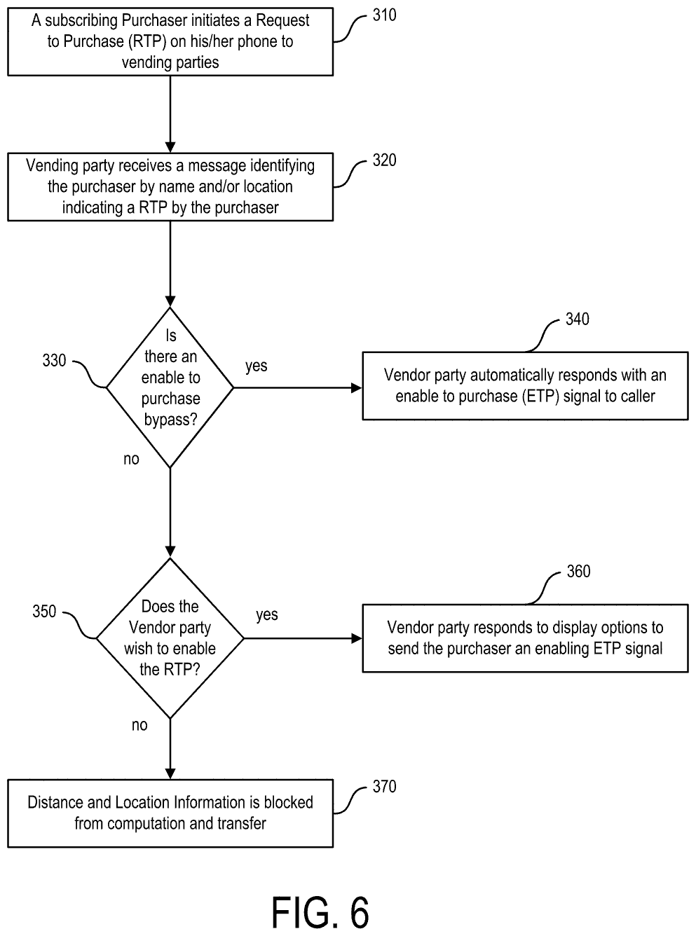

FIG. 6 depicts a flow chart of a method for a bypass or override of a location determination in accordance with an embodiment of the present disclosure. The method includes a subscribing purchaser initiating 310 an RTP on his/her phone for a tire make, size and price to multiple tire vending parties. The method also includes the vending party receiving 320 a message identifying the purchaser by name and/or location indicating an RTP by the caller. Also, determining 330 whether there is an ETL override is a logical part of the disclosed method that may be automated and manually performed. The purchaser may be required to enter an ETP override code in order for the ETP override to become activated. The ETP override may trigger the vendor party to automatically respond 340 with an ETP signal. In the absence of an ETP override, logic is disclosed for determining 350 whether the vendor party wishes to enable the purchaser's RTP. If the vendor party wishes to enable the purchaser's RTP, the vendor party responds 360 to his or her options to send the caller an enabling ETP signal. If the vendor party does not wish to enable the purchaser's RTP, distance and location information is blocked 370 from computation and transfer to the other party.

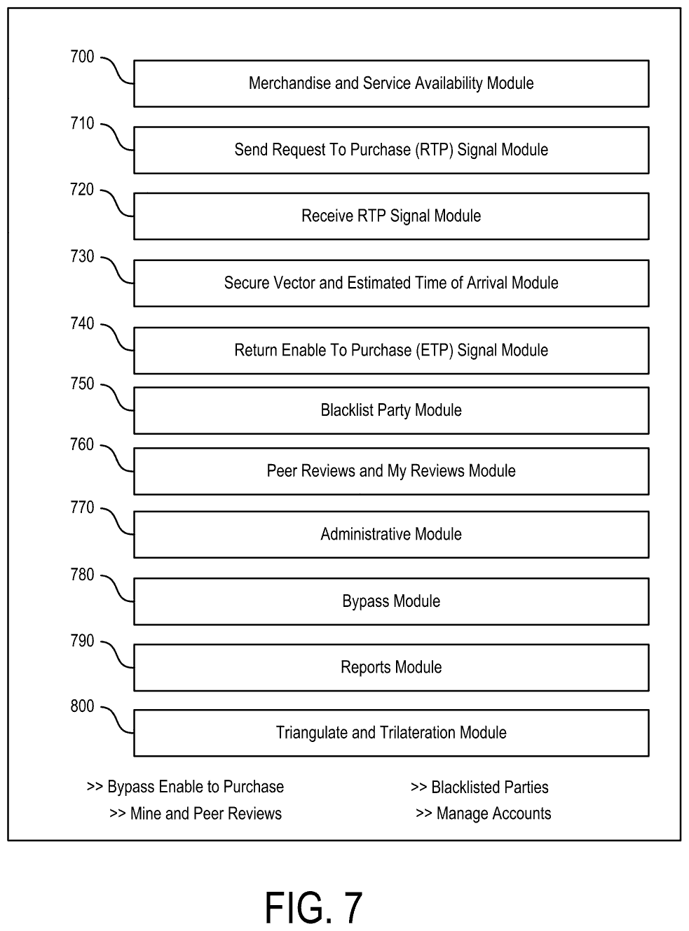

FIG. 7 is a block diagram of system components of the tires on-the-go purchasing method and mobile application in accordance with an embodiment of the present disclosure. The depiction includes a merchandise and service availability module 700, a sending RTP signal module 710, a receiving RTP signal module 720, a securing vector and ETA module 730, a returning ETP signal module 740, a blacklist party module 750, a review module 760, an administrative module 770, a bypass module 780, a reports module 790 and a triangulate and trilateration module 800.

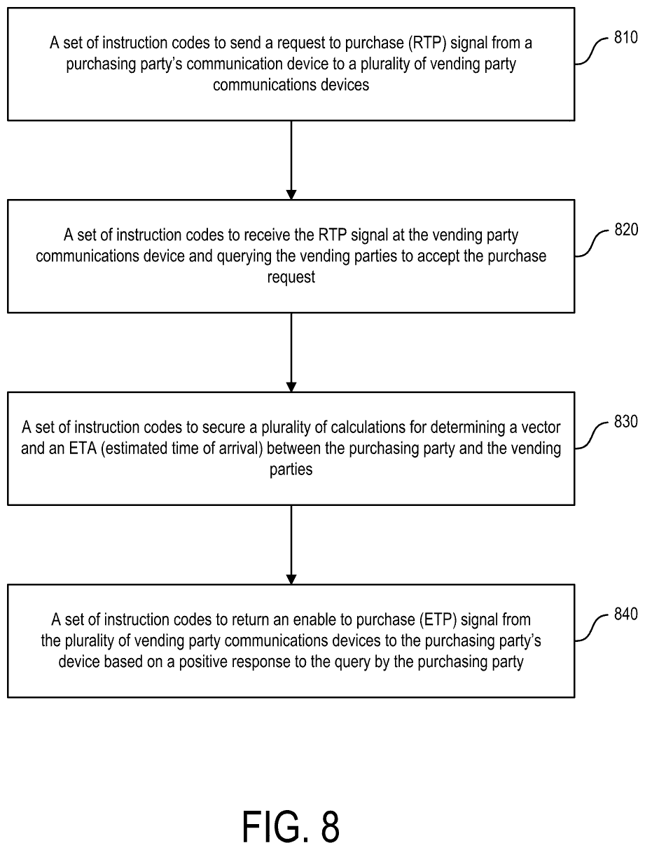

FIG. 8 is a flow chart of a computer program product for an on-the-go purchase in accordance with an embodiment of the present disclosure. The program code is executable to perform operations for mobile purchasing between parties via a secured network for sending 810 a request to purchase (RTP) signal from a purchasing party's communication device to a plurality of vending party communications devices, the RTP signal including a purchase request regarding the purchasing party. The program code also includes receiving 820 the RTP signal at the plurality of vending party communications devices and presenting the purchasing party's purchase request to the plurality of vending parties and querying the plurality of vending parties to accept the purchase request. The program code additionally includes securing 830 a plurality of calculations for determining a vector and an ETA (estimated time of arrival) between the purchasing party and the plurality of vending parties and a location for each vendor of the plurality of vending parties, a result of the calculations and location comprising a secured vending party data. The program code further includes returning 840 an enable to purchase (ETP) signal from the plurality of vending party communications devices to the purchasing party's device based on a positive response to the query by the purchasing party, the ETP signal including the secured data from the vector and the ETA and the purchase request.

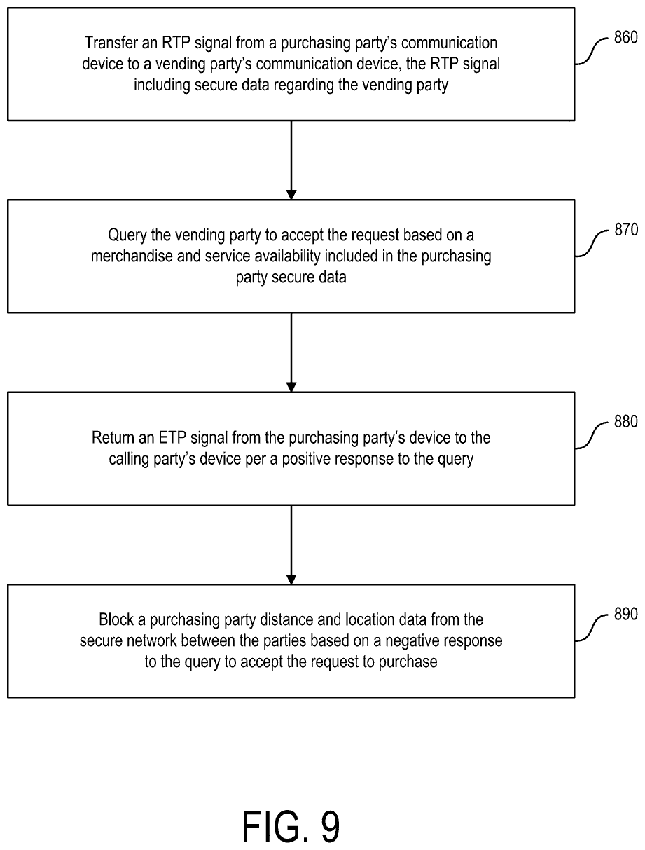

FIG. 9 is a flow chart of a method and mobile application for a communications protocol between parties in an on-the-go purchase in accordance with an embodiment of the present disclosure. The protocol includes transferring 960 a request to purchase (RTP) signal from a purchasing party's communication device to a vending party's communication device, the RTP signal including data regarding the purchasing party. The protocol also includes querying 970 the vending party to accept the request based on an availability of merchandise and service included in the request. The protocol additionally includes returning 980 an enable to purchase (ETP) signal from the vendor party's device to the purchasing party's device based on a positive response to the query, the ETP signal including location and distance data regarding the purchasing party. The disclosed protocol further includes blocking 990 a purchasing party distance and location data from transfer via the secure network between the parties based on a negative response to the query to accept the request to purchase.

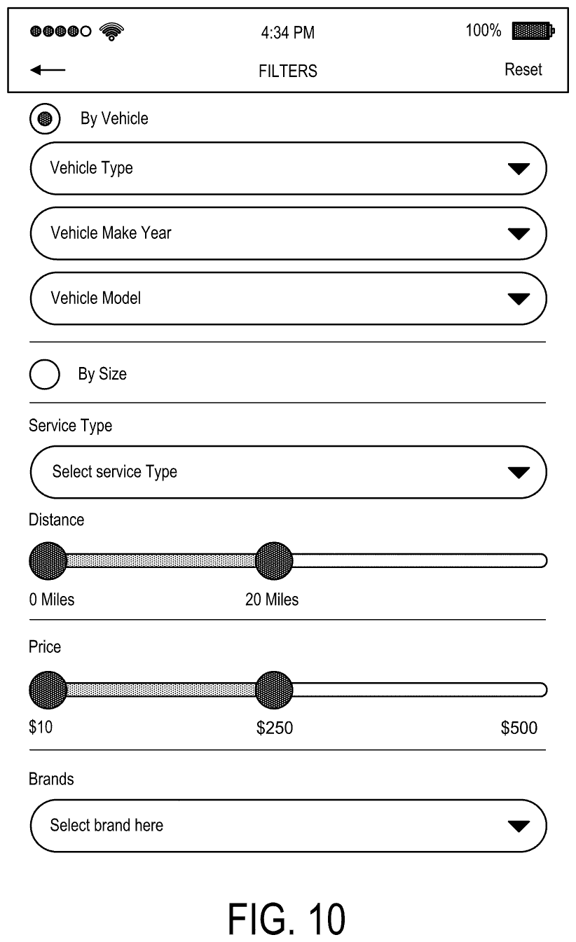

FIG. 10 is an illustration of a screen on a mobile phone for the disclosed mobile application in accordance with an embodiment of the present disclosure. The screen shot illustration in time includes a vehicle type, a vehicle make and year, a vehicle model and tire size. The screen shot also includes a service type option, a distance from a vendor for the service, a price for the service and tire brand names and logos. The customer and user of the application may select a distance and a price using a slider bar on a predetermined range. Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner

Although specific embodiments of the invention have been described and illustrated, the invention is not to be limited to the specific forms or arrangements of parts so described and illustrated. The scope of the invention is to be defined by the claims and their equivalents to be included by reference in a non-provisional utility application.

What is claimed is:

1. A method for a mobile purchase between parties via a network, comprising:
sending a request to purchase (RTP) signal from a purchasing party's communication device to a plurality of vending party communications devices, the RTP signal including a purchase request secure data regarding the purchasing party;
receiving the RTP signal at the plurality of vending party communications devices and presenting the purchasing party's purchase request to the plurality of vending parties and querying the plurality of vending parties to accept the purchase request;
securing a plurality of calculations for determining a vector and an ETA (estimated time of arrival) between the purchasing party and the plurality of vending parties and a location for each vendor of the plurality of vending parties, a result of the calculations and location comprising a secured vending party data; and
returning an enable to purchase (ETP) signal from the plurality of vending party communications devices to the purchasing party's device based on a positive response to the query by the purchasing party, the ETP signal including a secured data from the vector and the ETA and the purchase request.

2. The method of claim 1, further comprising the purchasing party choosing one of the plurality of vending parties for a sales and a service of the purchase request via the network of a voice, a data, an internet, a wireless and a satellite technology and any combination thereof.

3. The method of claim 1, wherein the purchasing party's purchase request comprises a tire brand, a tire size, a tire mileage, and an acceptable tire price.

4. The method of claim 1, further comprising scheduling a pickup and a service between the purchasing party and one of the plurality of vending parties.

5. The method of claim 1, further comprising the purchasing party providing a review of a chosen vending party's sales and service to other purchasers subscribing to the method.

6. The method of claim 1, further comprising presenting a plurality of reviews from other purchasing parties regarding a sales and a service of the plurality of vending parties.

7. The method of claim 1, wherein the sending, receiving, securing and returning are automated for a purchaser in a mobile application.

8. The method of claim 1, further comprising an administrator of the method taking a commission for a sale between the purchasing party and one of the plurality of vending parties.

9. The method of claim 1, further comprising the plurality of vendors generating various reports related to a sales transaction, a profit and an inventory related to the method.

10. The method of claim 1, wherein a communications device comprises any electronic electromagnetic communications device including a landline telephone, a cellular telephone, a voice-over-internet-protocol phone, a texting device, a computer, a personal digital assistant, a walkie-talkie, a satellite phone, a smart wrist-watch and the like.

11. The method of claim 1, wherein the purchasing party's data includes at least one of a name and a purchasing party's location based on whether the purchasing party is subscribed to an ‘on-the-go’ service and the purchasing party does not block a disclosure of his or her location.

12. The method of claim 1, wherein the plurality of vending party data includes at a vending party's name and a location based of the plurality of vending parties and whether the vending party is subscribed to an ‘on-the-go’ service and the vending party does not block a disclosure of its location.

13. The method of claim 1, wherein securing a plurality of calculations for determining a vector and an ETA between the purchasing party and the plurality of vending parties and a location for each vending party further comprises triangulating a location and a distance from the purchasing party to the plurality of vendors using a transmission time there between and multiple stationary wireless transmitters, landline relays and internet routers in the network.

14. The method of claim 1, wherein securing a plurality of calculations for determining a vector and an ETA between the purchasing party and the plurality of vending parties and a location for each, further comprises trilaterating data from GPS satellites to determine the distance there between and a respective location information for the parties.

15. The method of claim 1, further comprising bypassing the RTP accept query and automatically returning an ETP signal from the purchasing party's communication device to the plurality of vending party communication devices for certain business and personal relationships, the bypass based on one of a variable set in software and a switch set in the communications devices.

16. The method of claim 1, further comprising blacklisting an ETP signal coming from an undesired vending party specified by the purchasing party and automatically responding negatively to the query to accept the request and blocking the vector, the ETA and location data from calculation and transfer via the network between the parties.

17. The method of claim 1, wherein securing the estimated arrival time (ETA) between the parties is based on the calculated speed and direction of travel of the purchasing party relative to the vending parties.

18. A computer program product comprising a computer readable medium having computer useable instruction codes executable to perform operations for mobile purchasing between parties via a network, the operations of the computer program product comprising:
sending a request to purchase (RTP) signal from a purchasing party's communication device to a plurality of vending party communications devices, the RTP signal including a purchase request secure data regarding the purchasing party;
receiving the RTP signal at the plurality of vending party communications devices and presenting the purchasing party's purchase request to the plurality of vending parties and querying the plurality of vending parties to accept the purchase request;
securing a plurality of calculations for determining a vector and an ETA (estimated time of arrival) between the purchasing party and the plurality of vending parties and a location for each vendor of the plurality of vending parties, a result of the calculations and location comprising a secured vending party data; and
returning an enable to purchase (ETP) signal from the plurality of vending party communications devices to the purchasing party's device based on a positive response to the query by the purchasing party, the ETP signal including the secured data from the vector and the ETA and the purchase request.

19. The computer program product of claim 18, further comprising enabling a display of the purchasing party data, the vending party data and a third party data comprising an administrator on an electronic display device.

20. A system for mobile purchasing between parties via a network, comprising:
a sending module configured to send a request to purchase (RTP) signal from a purchasing party's communication device to a plurality of vending party communications devices, the RTP signal including a purchase request secure data regarding the purchasing party;
a receiving module configured to receive the RTP signal at the plurality of vending party communications devices and presenting the purchasing party's purchase request to the plurality of vending parties and querying the plurality of vending parties to accept the purchase request;
a securing module configured to perform a plurality of calculations for determining a vector and an ETA (estimated time of arrival) between the purchasing party and the plurality of vending parties and a location for each vendor of the plurality of vending parties, a result of the calculations and location comprising a secured vending party data; and
a returning module configured to return an enable to purchase (ETP) signal from the plurality of vending party communications devices to the purchasing party's device based on a positive response to the query by the purchasing party, the ETP signal including the secured data from the vector and the ETA and the purchase request.
